(19) United States
(12) Patent Application Publication
(10) Pub. No.: US 2011/0173027 A1
(43) Pub. Date: Jul. 14, 2011

(54) HEALTH-RISK METRIC DETERMINATION AND/OR PRESENTATION

(75) Inventors: Mark E. Olszewski, Solon, OH (US); Matthew J. Walker, Willoughby, OH (US)

(73) Assignee: KONINKLIJKE PHILIPS ELECTRONICS N.V., EINDHOVEN (NL)

(21) Appl. No.: 13/120,664

(22) PCT Filed: Oct. 6, 2009
(86) PCT No.: PCT/IB09/54367

§ 371 Date: Mar. 24, 2011

(30) Foreign Application Priority Data
Oct. 10, 2008 (US) 61/104310

(51) Int. Cl. G06Q 50/00

(52) U.S. Cl. 705/2

(57) ABSTRACT

A synthesizer that determines health-risk metrics includes a metric determiner that generates a first health-risk metric based on health related information, wherein the first health-risk metric indicates a first health state of a first local region of interest of a subject.

The following generally relates to determining and/or presenting a health-risk metric for a subject.

Various information has been used to derive health risk information for patients. For example, cardiac calcium scoring, which is a non-invasive CT imaging based procedure, can be used to identify plaque build up in the coronary arteries by identifying calcium deposits, which generally are bio-markers of coronary artery disease. That is, as plaque deposits build up in the arteries, the blood vessels narrow, allowing less blood and oxygen to the heart. The calcium score quantifies the amount of calcified plaque and may help predict the likelihood of a myocardial infarction in the near future, or at least classify the subject in a demographic profile such as low, medium or high risk for a myocardial infarction. For example, a score of zero may indicate no or substantial absence of plaque and a low likelihood of myocardial infarction, whereas a score of four hundred may indicate extensive plaque and a strong likelihood of coronary artery disease and myocardial infarction within the next couple of years. Scores within this range may indicate a degree of coronary artery disease from minimal to moderate.

Numerous other markers may also be used to indicate coronary artery disease. For example, coronary artery disease may involve one or more of inflammation, lipid accumulation, plaque rupture, thrombosis, vascular remodeling in native and/or grafted vessels (e.g., carotid, aortic, coronary, cerebral, renal, peripheral, etc.), etc. As such, information indicative of such factors may also be used to indicate a likelihood of coronary artery disease. The literature has also associated biomechanical features such as local hemodynamic stresses and vascular geometry with the progression of heart disease. Still other markers include biological, mechanical, environmental, lifestyle, diet, genetics, etc. factors. Such information may be in the form of blood tests, stress tests, images from various medical imaging modalities, family history, genetics, demographics, sex, weight, age, race, behavior, etc. Unfortunately, the number and type of factors may make it difficult, if not essentially impossible, to summarize the risk associated with the various different factors.

Aspects of the present application address the above-referenced matters and others.

In one aspect, a synthesizer includes a metric determiner that generates a first health-risk metric based on health related information, wherein the first health-risk metric indicates a first health state of a first local region of interest of a subject.

In another aspect, a method includes obtaining information indicative of a health state of a subject, synthesizing at least a sub-set of the information, generating at least one health-risk metric for the subject based on the synthesis, and presenting the at least one health-risk metric.

In another aspect, a method includes generating a first health-risk metric for a subject based on information about a health state of a subject, generating a second health-risk metric for the subject based on information about a health state of a subject and a known health related affect of the pharmaceutical, and predicting the effectiveness of the pharmaceutical based on the first and second health-risk metrics.

In another aspect, a method includes generating a first health-risk metric for a subject based on information about a health state of a subject, generating a second health-risk metric for the subject based on information about a health state of a subject and a known health related affect of the implant, and predicting the effectiveness of the implant based on the first and second health-risk metrics.

In another aspect, a method includes simulating a plurality of health-risk metrics for a subject, wherein each metric is based on information corresponding to a different treatment and selecting a treatment for the subject based on the simulated plurality of health-risk metrics.

In another aspect, a method includes determining a health-risk metric for a local region of a subject and using the health-risk metric to automatically guide an instrument to the local region of the subject for a procedure.

The invention may take form in various components and arrangements of components, and in various steps and arrangements of steps. The drawings are only for purposes of illustrating the preferred embodiments and are not to be construed as limiting the invention.

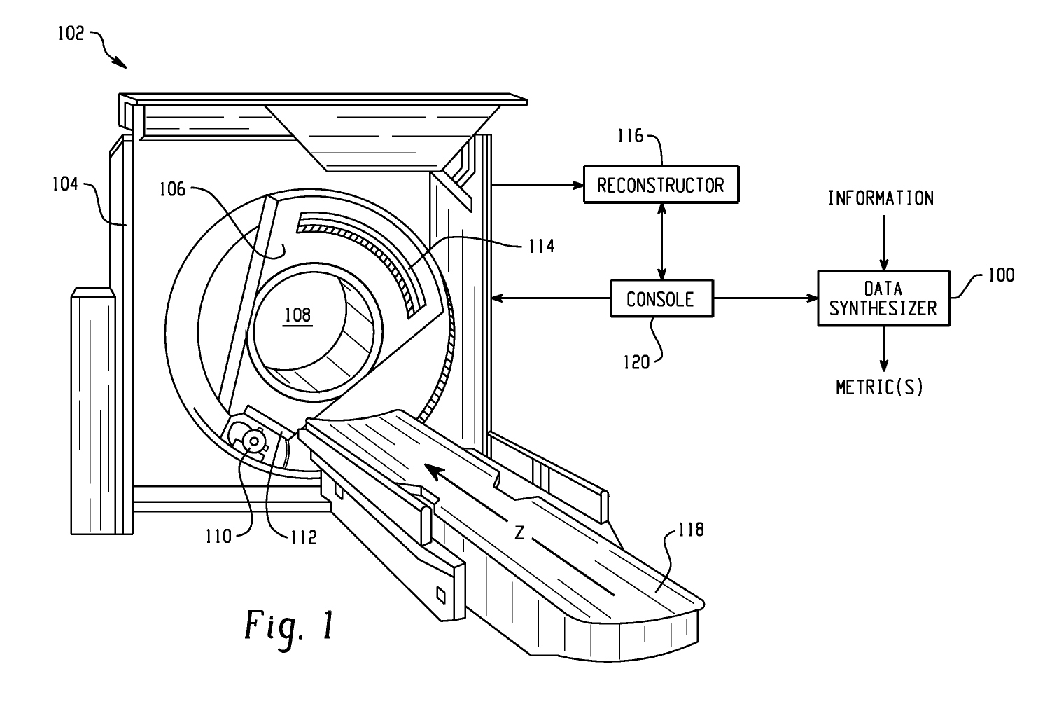

FIG. 1 illustrates a data synthesizer in connection with an imaging apparatus.

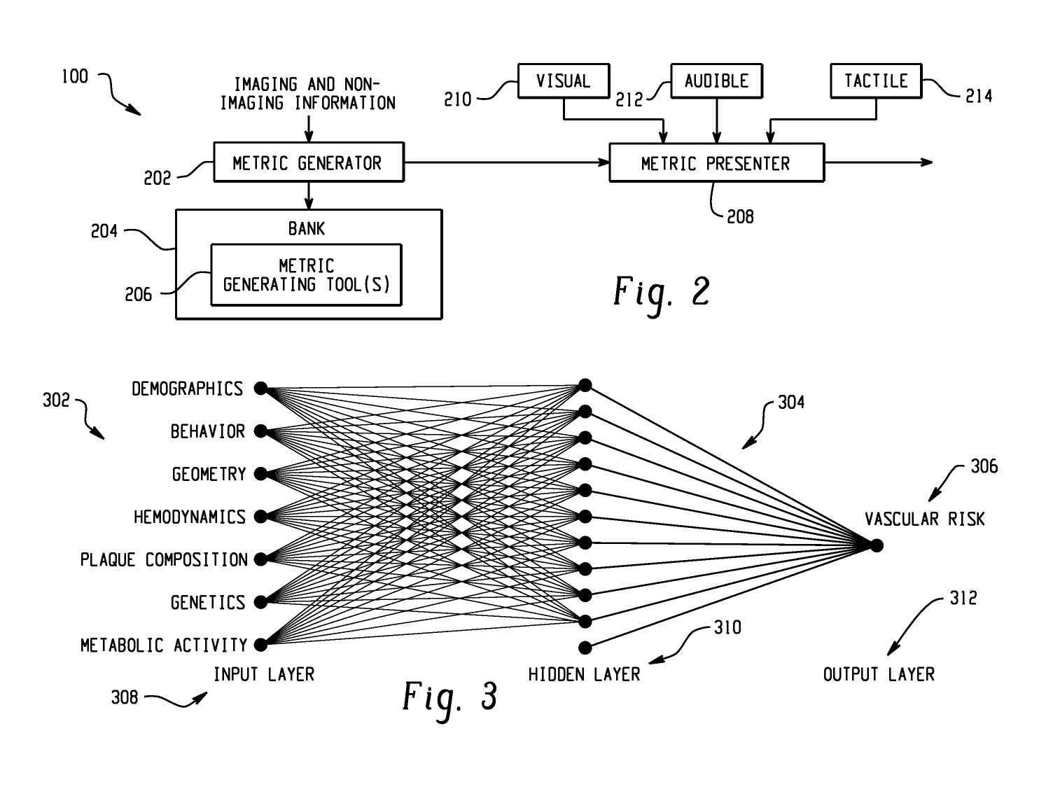

FIG. 2 illustrates an example data synthesizer.

FIG. 3 illustrates an example data synthesis approach.

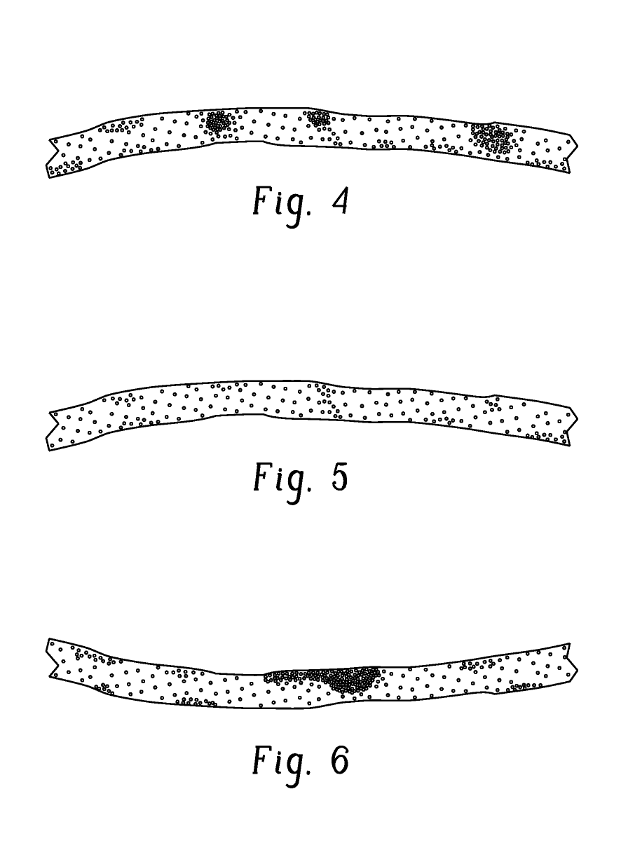

FIG. 4 illustrates risk at time t1 superimposed on an image.

FIG. 5 illustrates risk at time t2 superimposed on an image.

FIG. 6 illustrates risk summary map superimposed on an image.

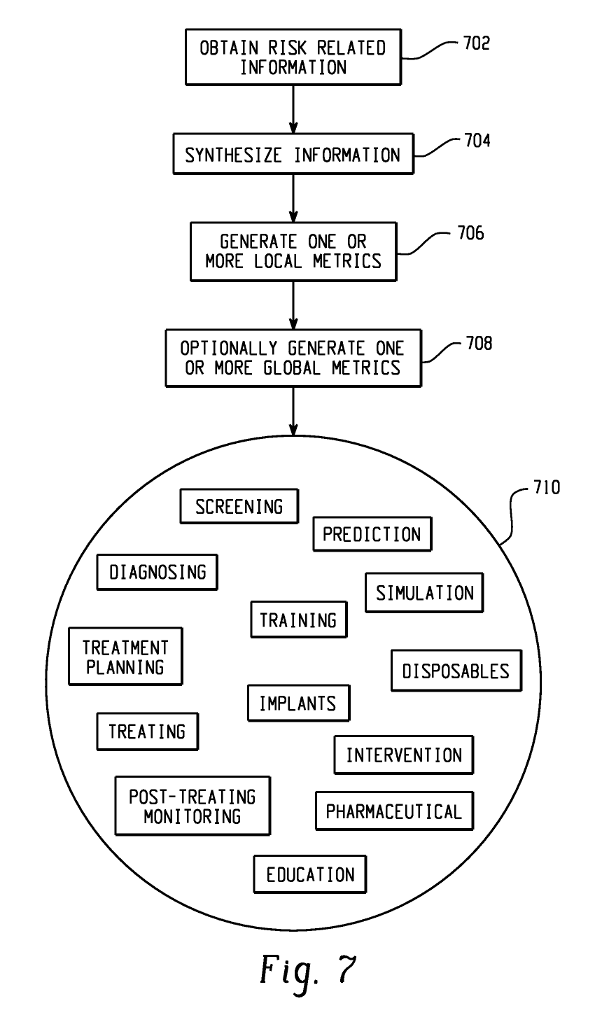

FIG. 7 illustrates a method.

FIG. 1 illustrates a data synthesizer 100 in connection with an imaging system 102. The data synthesizer 100 synthesizes various information, including imaging and/or non-imaging information such as information about a patient, another person and/or a population, simulated data, modeled data, theoretical data, etc., and generates one or more health-risk metrics based thereon.

In one instance, at least one of the one or more health-risk metrics is a local health-risk metric that corresponds to a particular or local sub-portion of tissue, such as a particular section of a vessel, the lung, the liver, bone, etc. By way of non-limiting example, such a health-risk metric may be local to a sub-portion of one of the coronary arteries and indicative of a likelihood of a state such as a likelihood of an abnormal physiological condition of the coronary arteries, other tissue and/or the general heath of the patient, previously, presently, and/or in the future.

Another one of the health-risk metrics may be associated with a different sub-portion of the tissue, different tissue, and/or a different state. Additionally or alternatively, at least one of the one or more health-risk metrics may represent a global metric in that rather being localized to a sub-portion of tissue, it may provide information indicative of a general state of the patient. Additionally or alternatively, at least one of the one or more health-risk metrics may represent a change in the state. The one or more health-risk metrics may be stored in memory, provided to another system, and/or variously presented.

As discussed in greater detail below, the one or more health-risk metrics may be used to screen a patient, predict an outcome of an intervention, diagnose a patient, plan a treatment for a patient, treat the patient, and/or monitor post-treatment of the patient, predict and/or monitor the effectiveness of a pharmaceutical, an implantable, a disposable, etc., guide an instrument, etc., teach clinicians, etc. The relative risk conveyed in the one or more health-risk metrics can also be used to weigh the relative risk to benefit ratio in the context of a specific clinical question such as should a lesion be treated, should medical therapy be started/increased/decreased, what is the chance of an acute event with or without intervention, what change in relative risk has occurred longitudinally, etc.

The illustrated imaging system 102 is a computed tomography (CT) scanner. However, it is to be appreciated that the synthesizer 100 may additionally or alternatively be employed in connection with one or more other imaging modalities such as positron emission tomography (PET), single photon emission computed tomography (SPECT), magnetic resonance imaging (MRI), ultrasound (US), x-ray, spectral CT, etc. In another instance, the imaging system 102 is omitted. Information from the imaging system 102 can be used by the data synthesizer 100 to generate and/or present the one or more health-risk metrics.

The illustrated CT scanner 102 includes a stationary gantry 104 and a rotating gantry 106, which is rotatably supported by the stationary gantry 104. The rotating gantry 106 rotates around an examination region 108 about a longitudinal or z-axis. A radiation source 110, such as an x-ray tube, is supported by and rotates with the rotating gantry 106, and emits radiation. A source collimator 112 collimates the radiation to form a generally fan, wedge, or cone shaped radiation that traverses the examination region 108.

A radiation sensitive detector array 114 detects photons emitted by the radiation source 110 that traverse the examination region 108 and generates projection data indicative of the detected radiation. The illustrated radiation sensitive detector array 114 includes one or more rows of radiation sensitive photosensor pixels.

A reconstructor 116 reconstructs the projection data and generates volumetric image data indicative of the examination region 108, including any region of an object or subject disposed therein. A support 118, such as a couch, supports the object or subject in the examination region 108. The support 118 is movable along the z-axis in coordination with the rotation of the rotating gantry 106 to facilitate helical, axial, or other desired scanning trajectories. A general purpose computing system serves as an operator console 120, which includes human readable output devices such as a display and/or printer and input devices such as a keyboard and/or mouse. Software resident on the console 120 allows the operator to control the operation of the system 102, for example, by allowing the operator to select a scan protocol, initiate and terminate scanning, view and/or manipulate the volumetric image data, and/or otherwise interact with the system 102.

Turning to FIG. 2, the data synthesizer 100 includes a metric generator 202 that generates the one or more health-risk metrics. In the illustrated embodiment, the metric generator 202 receives both non-imaging and imaging data, including data from the scanner 102. Such information can be obtained from PACS, HIS, RIS, and/or other data storage systems, including local, remote and/or portable storage. A bank 204 includes one or more metric generating tools 206 that can be used to generate the one or more health risk metrics. The one or more tools 206 may include, but are not limited to, an implicitly and/or explicitly trained classifier, a Bayesian network, a support vector machine, an inference engine, a cost function, a statistic, a probability, a heuristic, historical information, a model, a mathematical equation, a computer simulation, a theory, a rule, etc.

By way of example, in a relatively simple implementation the metric generator 202 employs a tool 206 that sums individual risk factors to produce the one or more health-risk metrics. In a relatively more complex (or less simple) implementation, a machine learning approach is employed to generate the one or more health-risk metrics. Briefly turning to FIG. 3, a non-limiting example is illustrated in connection with determining a vascular risk metric. As shown, various inputs 302 such as markers or factors are processed by a neural network 304 to generate a vascular risk metric 306. In this example, the various inputs 302 include demographics, behavior, tissue geometry, hemodynamics, plaque composition, genetics, and metabolic activity. Such data is provided to an input layer 308, synthesized in a hidden layer 310, and combined and output in an output layer 312.

Of course additional or alternative factors may be used to determine the vascular risk metric 306. For example, other factors may include, but are not limited to, a rate of plaque progression or regression, risk of plaque rupture, degree of stenosis, branching pattern, curvature, tortuosity, eccentricities, plaque composition, vascular remodeling, hemodynamics (e.g., shear stresses, flow characteristics), contrast kinetics (e.g., contrast uptake, targeted contrast agent profiles, etc.), metabolic activity (e.g., macrophage activity, etc.), inflammatory pathways, demographics (e.g., age, gender, race, body mass index, etc.), lifestyle or behavior, number of vessels affected, and other diagnostic and prognostic markers of risk (e.g., vascular compliance, distensibility, degree of angiogenesis, motion, calcium score, Framingham risk, etc.), and/or other information.

Returning to FIG. 2, the data synthesizer 100 also includes and a metric presenter 208, which presents information indicative of the one or more health-risk metrics. The metric presenter 208 can employ various presentation techniques to present the metric. For examples, the metric presenter 208 can employ visual 210, audible 212 and/or tactile 214 techniques to present the metric. Examples of visual techniques include, but are not limited to, color maps, texture maps, surface rendering, volume rendering, virtual renderings, etc., examples of audible techniques include, but are not limited to, beep patterns, varying tones, computer simulated voice, voice recording playback, etc., and examples of tactile techniques include, but are not limited to, vibration, force, a change in temperature, texture, etc.

The metric presenter 208 may also variously deliver and/or convey such information to one or more devices via wire and/or wirelessly transmission mediums. This may include providing information to the console 120, a monitor, a computer, a workstation, a web based application, a web client, a cell phone, a pager, a personal data assistant, a laptop, a hand held computer, a television, a set top box, a radio, a distributed system, a database, a server, an archiver, and/or other destinations. The format of the information (visual, audible and/or tactile) may depend on the presentation capabilities of the destination device. Recipients of such information may include, but are not limited to, physicians, patients, and/or other authorized personal.

By way of example, FIGS. 4, 5 and 6 show health-risk metrics presented in connection with image data from the scanner 102 and/or other scanner. Initially referring to FIG. 4, local health-risk metrics are superimposed over a rendering of a portion of a vessel of interest, with the metrics being mapped to voxels including corresponding portions of the vessel. In this embodiment, different patterns are used to indicate a degree of risk for each voxel in the image. In an alternative embodiment, a gray scale (e.g., 8-bit or 256 shades of gray) can be used to indicate different degrees of risk. In yet another embodiment, a color map can be used. In this embodiment, different colors can be mapped to pre-determined ranges of gray scale values. For instance, varying shades of red may be respectively mapped to values in a gray scale range corresponding to high risk, and varying shades of green may be respectively mapped to values in a gray scale range corresponding to less than high risk.

In FIG. 5, the mapped local risk is associated with a different point in time relative to FIG. 4. This risk may represent a risk value at the different point in time or a change such as a difference in the metric from the earlier time. The change may be the result of an actual or simulated change in behavior, interventional procedure, treatment, surgery, healing, implant, pharmaceutical, etc. FIG. 6 shows another representation, which provides a summary map in which high and low local regions of risk are identified, with corresponding degrees of risk. In one instance, a predetermined threshold is used to categorize the health risk metric at high or low risk. It is to be appreciated that in another instance that summary map may include a smaller or larger portion of the subject, including the entire subject, and the metrics can be related to different disease, pathologies, states, conditions, treatments, procedures, etc.

FIG. 7 illustrates a method for generating the health-risk metric. At 702, available information related to a health risk or state of a patient is obtained. As noted above such information can include imaging information and non-imaging information, such as patient specific information like test results, behavior, genetics, sex, age, weight, medical history, known pathologies, etc., population based information, known and/or simulated affects of pharmaceuticals, implants, treatment and/or intervention, and/or other information.

At 704, at least a portion of this information is synthesized. As noted above, various algorithms, techniques, approaches, etc. can be used to synthesize the data. It is also noted that all or a sub-set of the information can be synthesized. In addition, different sets of the information can be synthesized. In one instance, the make up of a particular set is manually determined by a clinician, while in another instance the information for any particular set is automatically determined base on rules and/or other techniques.

At 706, one or more localized metrics are generated based on the one or more sets of synthesized information. It is to be appreciated that at least two of the metrics can correspond to the same sub-portion of tissue. For example, at least two different sets of available information can be used to separately and independently determine metrics localized to the sub-portion of tissue. Various differences may exist for the different sets of information. For example, one set may include a known reaction to an interventional procedure while the other set includes a known result of a surgical procedure. As such, the metrics may facilitate deciding or selecting between two or more courses of action. Another metric can be determined for the sub-portion based on the at least two metrics, for example, by variously combining the at least two metrics. Alternatively, the multiple metrics may correspond to different sub-portions of same tissue or different tissue, for example, two different anatomical structures.

Optionally, at 708, one or more global metrics can be generated. Such metrics can be based on the localized metrics or determined independently therefrom. In contrast to a localized metric, a global metric may provide general health risk information for the patient. For example, a global metric may indicate that the patient is at risk for coronary heart disease, whereas a local metric may indicate that a state of a sub-portion of a coronary artery places the patient at risk for coronary heart disease. A clinician can use one or both indicators for the patient.

As shown at 710, the one or more local and/or global metrics can be variously used. This includes using the metric(s) for screening, intervention, diagnosing, treatment planning, treating and/or post-treatment monitoring. The metric(s) can also be used for pre-clinical trials of pharmaceuticals. For instance, information about a patient(s) can be synthesized with known information about a pharmaceutical to simulate or predict an outcome of administering the pharmaceutical to the patient. Such information can be compared and/or otherwise used in conjunction with a metric generated without the pharmaceutical information, which may facilitate determining whether the pharmaceutical is likely to increase or decrease risk. The above can be used by pharmaceutical developers and manufacturers, parties on behalf of pharmaceutical developers and manufacturers, and/or others to predict the effectiveness of a pharmaceutical. The metric can also be used to monitor the patient after administration of a pharmaceutical to a patient.

Likewise, the metric(s) can be used to simulate, predict, monitor, etc. the affect an implant or disposable will have on a patient. In this instance, the information synthesized may include known information about the implant or disposable. Metrics generated before and after an actual or simulated implant or disposable can be compared for changes in risk. The metric(s) may also be used for education, training, predicting risk changes due to changes in behavior, etc. It is to be understood that the above example are provided for clarity, brevity, and explanatory purposes, and are not limiting.

It is also to be understood that the one or more metrics can be updated during a procedure based on information obtained during the procedure. In one instance, this may facilitate determining whether the procedure should continue or be terminated. In another instance, the metric may facilitate locating a region of interest. This may include providing a varying visual, sound and/or resistive force as an instrument such as a guide wire traverses to a region associated with a health-risk of interest. In one instance, such information can be used to automatically steer the guide wire to the region. The visual pattern, sound and/or resistive force may change during the procedure as the health-risk metric changes. Such feedback may also be used in connection with training, for example, on a simulated, virtual, decease and/or actual patient.

It is to be appreciated that the data synthesizer 100 can federate, synthesize, present, store, manipulate, etc. the information obtained from various data storage or archive system, including the system noted herein, risk metrics, risk summary maps, etc. generated by the data synthesizer 100 and/or another system, and/or other information. Such federation may be provided through a federation layer and/or federation service and/or a hardware platform, which can manage such risk information. The federation layer, service and/or platform may also be separate from the data synthesizer 100.

The above may be implemented by way of computer readable instructions, which when executed by a computer processor(s), cause the processor(s) to carry out the described acts. In such a case, the instructions are stored in a computer readable storage medium associated with or otherwise accessible to a relevant computer, such as a dedicated workstation, a home computer, a distributed computing system, the console 120, and/or other computer. The acts need not be performed concurrently with data acquisition.

The invention has been described herein with reference to the various embodiments. Modifications and alterations may occur to others upon reading the description herein. It is intended that the invention be construed as including all such modifications and alterations insofar as they come within the scope of the appended claims or the equivalents thereof.

1. A synthesizer that determines health-risk metrics, comprising:
a metric generator that generates a first health-risk metric based on health related information, wherein the health related information includes both imaging and non-imaging information and the first health-risk metric indicates a first health state of a first local region of interest of a subject which is a sub-region of the subject.

2. (canceled)

3. The synthesizer of any of claim 1, wherein the metric generator generates at least one global health-risk metric that indicative a global state of the subject.

4. The synthesizer of claim 1, wherein the first health state corresponds to a degree of health risk associated with the first local region.

5. The synthesizer of claim 1, wherein the metric generator generates at least a second health-risk metric that indicates a second health state of a second local region of interest of the subject.

6. The synthesizer of claim 5, wherein the first and second health-risk metrics correspond to the same local region of interest and are generated using different sets of the health-related information.

7. The synthesizer of claim 5, wherein the first and second local regions of interest are different regions of interest of the subject.

8. The synthesizer of any of claim 1, further including:
a metric presenter that presents the first health-risk metric via at least one of a visual, an audible, or a tactile presentation.

9. The synthesizer of claim 8, wherein the visual presentation include superimposing the first health-risk metric over an image.

10. The synthesizer of claim 9, wherein the first health-risk metric is superimposed over one or more voxels of the image corresponding to the first local region of interest.

11. The synthesizer of claim 8, wherein the first health-risk metric is displayed through at least one of a pattern, a gray scale, and color, which is indicative of a degree of risk corresponding to the first health-risk metric.

12. The synthesizer of claim 8, wherein the first health-risk metric corresponds to a change in health risk associates with at least one of a simulation, an intervention, a treatment, or a change in behavior.

13. The synthesizer of claim 8, wherein the tactile presentation include tactile feedback, comprising at least one of a force, a vibration, texture, or a change in temperature.

14. A method, comprising:
obtaining information indicative of a health state of a subject;
synthesizing at least a sub-set of the information;
generating at least one health-risk metric for the subject based on the synthesis; and
presenting the at least one health-risk metric.

15. The method of claim 14, further including dynamically updating the at least one health-risk metric in response to obtaining additional information.

16. The method of claim 14, further including at least one of screening, diagnosing, treatment planning, treating, or post-treatment monitoring of the subject based on the at least one health-risk metric.

17. The method of claim 14, wherein the at least one health-risk metric is local to a sub-region of tissue of interest of the subject.

18. The method of claim 14, wherein the at least one health-risk metric is global to the subject.

19. (canceled)

20. The method of claim 14, further including presenting the at least one health-risk metric via at least one of a visual, an audible, or a tactile presentation.

21. The method of claim 14, further including mapping the at least one health-risk metric to an image of the subject.

21. The method of claim 21, wherein the mapping includes mapping indicia that shows a relative degree of risk associated with the at least one health-risk metric.

22. The method of claim 14, further including generating the at least one health-risk metric using information about a pharmaceutical and predicting an effectiveness of the pharmaceutical for the subject based on the at least one health-risk metric.

23. The method of claim 21, further including monitoring an effect of the pharmaceutical administered to the subject based on a health-risk metric determined after the administration of the pharmaceutical to the subject with information available after the administration.

24. The method of claim 14, further including generating the at least one health-risk metric using information about an implant and predicting an effectiveness of the implant for the subject based on the at least one health-risk metric.

25. The method of claim 24, further including monitoring an effect of the implant implanted in the subject based on a health-risk metric determined after the implantation of the implant in the subject with information available after the implantation.

26. The method of claim 14, further including:
generating at least one second health-risk metric for the subject at a different moment in time; and
presenting a difference between the at least one metric and the at least one second health-risk metric.

27. A method of predicting an effectiveness of a pharmaceutical, comprising:
generating a first health-risk metric for a subject based on information about a health state of a subject;
generating a second health-risk metric for the subject based on information about a health state of a subject and a known health related affect of the pharmaceutical; and
predicting the effectiveness of the pharmaceutical based on the first and second health-risk metrics.

28. The method of claim 26, further including:
comparing the first and second health-risk metrics; and
predicting whether the pharmaceutical will increase or decrease the health-risk metric.

29. A method of predicting an effectiveness of an implant, comprising:
generating a first health-risk metric for a subject based on information about a health state of a subject;
generating a second health-risk metric for the subject based on information about a health state of a subject and a known health related affect of the implant; and
predicting the effectiveness of the implant based on the first and second health-risk metrics.

30. The method of claim 29, further including:
comparing the first and second health-risk metrics; and
predicting whether the implant will increase or decrease the health-risk metric.

31. A method for selecting a treatment for a patient, comprising:
simulating a plurality of health-risk metrics for a subject, wherein each metric is based on information corresponding to a different treatment; and
selecting a treatment for the subject based on the simulated plurality of health-risk metrics.

32. A method, comprising:
determining a health-risk metric for a local region of a subject; and
using the health-risk metric to automatically guide an instrument to the local region of the subject for a procedure.
